(19) United States
(12) Patent Application Publication
(10) Pub. No.: US 2009/0055010 A1
(43) Pub. Date: Feb. 26, 2009

(54) Back annotation equipment, mask layout correcting equipment, back annotation method, program, recording medium, process for fabricating semiconductor integrated circuit

(76) Inventor: Masami Tanaka, Kyoto (JP)

Correspondence Address: MCDERMOTT WILL & EMERY LLP, 600 13TH STREET, N.W., WASHINGTON, DC, 20005-3096, US

(21) Appl. No.: 11/597,180

(22) PCT Filed: Jan. 25, 2005
(86) PCT No.: PCT/JP05/00917

§ 371 Date: Nov. 21, 2006

(30) Foreign Application Priority Data
Jun. 3, 2004 (JP) 2004-166236

(51) Int. Cl. G06F 19/00; G06F 17/50

(52) U.S. Cl. 700/110; 703/15; 716/19

(57) ABSTRACT

The present invention provides a back annotation apparatus for determining the delay value of a logic cell used in a timing simulation in view of the changes in the properties of a transistor element to be disposed at a position overlapped with an electrode pad of a semiconductor IC. The back annotation apparatus comprises: a storage unit storing therein mask layout information that includes information on positions of electrode pads and logic cells in a semiconductor integrated circuit; an identification unit operable to identify, with respect to each of the logic cells, whether the logic cell is to be disposed at a position overlapped with an electrode pad in plan view, based on the mask layout information; and a selection unit operable to select a delay value for the logic cell according to an identification result obtained by the identification unit.

### TECHNICAL FIELD

The present invention relates to design technology for a semiconductor integrated circuit (IC), in particular to technology for performing back annotation and mask layout correction in view of a change in the property of a transistor element constituting a semiconductor IC.

### BACKGROUND ART

Designing semiconductor ICs is generally conducted in the order of function design, logic design, and layout design, and a simulation is implemented for verification of operation at each design stage.

A timing simulation performed after the layout design uses timing information, that is, information on signal delay. The timing information can be determined from mask layout information created in the layout design. A process of reflecting the determined timing information in the timing simulation, or the timing simulation performed in the light of the timing information, is referred to as back annotation.

A back annotation method disclosed by Patent Reference 1 below is one example of inventions related to conventional back annotation.

Along with recent multifunctionalization of semiconductor ICs, the number of electrode pads disposed on the outer layer of a semiconductor IC and used for each functional input and output has increased. Accordingly, this has raised a problem of having to increase the chip size even though there is a demand for the reduction.

One solution to this problem considered is, as in a semiconductor apparatus disclosed by Patent Reference 2 below, to provide transistor elements on the inner layer at positions where they are conventionally not provided—i.e. positions corresponding to the electrode pads on the outer layer.

<Patent Reference 1> Japanese Laid-Open Patent Application No. 2000-194734

<Patent Reference 2> Japanese Patent Publication No. 2559102

### DISCLOSURE OF THE INVENTION

### Problems that the Invention is to Solve

The applicants of the present application are engaged in the development of an integrated circuit in which transistor elements are disposed at such positions that they are overlapped with the electrode pads in plan view. As a part of the development, they conducted an experiment to see if the property of such a transistor element changes when pressure is applied to the transistor element.

The results confirm that the property changes when a certain degree of pressure is applied to the transistor element from outside. Note here that the “certain degree of pressure” means the pressure at which the transistor element is not destroyed.

In addition, the experiment has determined that a logic cell including therein a transistor element disposed at a position overlapped with an electrode pad of a semiconductor IC has a different transmission delay time, as compared to a normal case, due to the pressure applied to the electrode pad.

In view of the change in the property of a transistor, the present invention has (i) a first object of providing a back annotation apparatus for determining a delay value, which is a value corresponding to a transmission delay time of a logic cell used in a timing simulation, and technologies relating to the back annotation apparatus; (ii) a second object of providing a mask layout correction apparatus for correcting mask layout information; and (iii) a third object of providing a method of manufacturing a semiconductor IC in which the property change of a transistor is taken into account.

### Means to Solve the Problem

In order to achieve the first object above, the back annotation apparatus of the present invention comprises: a storage unit storing therein mask layout information that includes information on positions of electrode pads and logic cells in a semiconductor integrated circuit; an identification unit operable to identify, with respect to each of the logic cells, whether the logic cell is to be disposed at a position overlapped with an electrode pad in plan view, based on the mask layout information; and a selection unit operable to select a delay value for the logic cell according to an identification result obtained by the identification unit.

### ADVANTAGEOUS EFFECTS OF THE INVENTION

Since selecting a delay value for a logic cell according to whether the logic cell is to be disposed at a position overlapped by an electrode pad, the back annotation apparatus having the above structure is capable of accurately simulating operation timings of the semiconductor integrated circuit in which transistor elements are to be disposed at positions overlapped with electrode pads. Accordingly, this prevents, when possible, the occurrence of situations in which a timing error due to a change in the property of a transistor element disposed at a position overlapped with an electrode pad turns out after manufacturing of the semiconductor integrated circuit.

In the above-mentioned back annotation apparatus, the storage unit may store therein (i) a 1^{st} delay value which is used in the case where the logic cell is to be disposed at a position not overlapped with an electrode pad and (ii) a 2^{nd} delay value which is used in the case where the logic cell is to be disposed at a position overlapped with an electrode pad, and the selection unit may select one of the 1^{st} delay value and the 2^{nd} delay value as the delay value for the logic cell according to the identification result. Here, the 2^{nd} delay value may vary in accordance with pressure imposed on the overlapping electrode pad. In addition, the pressure may be pressure generated when a probe for an electric characteristic test is in contact with the overlapping electrode pad in a manufacturing stage where the semiconductor integrated circuit is in a wafer state.

In the above-mentioned back annotation apparatus, the storage unit may store therein (i) a 1^{st} delay value which is used in the case where the logic cell is to be disposed at a position not overlapped with an electrode pad and (ii) a coefficient to be used for calculating a 2^{nd} delay value which is used in the case where the logic cell is to be disposed at a position overlapped with an electrode pad, and the selection unit may select one of the 1^{st} delay value and the 2^{nd} delay value calculated using the coefficient, as the delay value for the logic cell according to the identification result. Here, the coefficient may be used to calculate the 2^{nd} delay value that varies in accordance with pressure imposed on the overlapping electrode pad.

In the above-mentioned back annotation apparatus, the semiconductor integrated circuit may have a multilayer structure. Here, the identification unit identifies a count of wiring layers to constitute the semiconductor integrated circuit in the case where the logic cell is to be disposed at a position overlapped with an electrode pad, and the selection unit selects the delay value for the logic cell according to all identification results obtained by the identification unit.

According to the structure, the back annotation apparatus is capable of identifying the count of the wiring layers while identifying whether the logic cell is to be disposed at a position overlapped with an electrode pad, and reliably selecting a delay value for the logic cell, which varies depending on the count of wiring layers.

In the above-mentioned back annotation apparatus, the storage unit may store therein (i) a delay value used in the case where the logic cell is to be disposed at a position not overlapped with an electrode pad and (ii) delay values, each of which (a) is used in the case where the logic cell is to be disposed at a position overlapped with an electrode pad and (b) is associated with a different count of the wiring layers, and the selection unit may select one of the delay values as the delay value for the logic cell according to all the identification results.

In the above-mentioned back annotation apparatus, the storage unit may store therein (i) a delay value used in the case where the logic cell is to be disposed at a position not overlapped with an electrode pad and (ii) coefficients, each of which (a) is to be used for calculating a delay value which is used in the case where the logic cell is to be disposed at a position overlapped with an electrode pad and (b) is associated with a different count of the wiring layers, and the selection unit may select one of the delay value stored in the storage unit and the delay values calculated using the coefficients, as the delay value for the logic cell according to all the identification results.

In the above-mentioned back annotation apparatus, the identification unit may identify an overlapping pattern in the case where the logic cell is to be disposed at a position overlapped with an electrode pad, and the selection unit may select the delay value for the logic cell according to all identification results obtained by the identification unit.

In the above-mentioned back annotation apparatus, the storage unit may store therein (i) a delay value used in the case where the logic cell is to be disposed at a position not overlapped with an electrode pad and (ii) delay values, each of which is used in the case where the logic cell is to be disposed at a position overlapped with an electrode pad in a predetermined overlapping pattern, and the selection unit may select one of the delay values as the delay value for the logic cell according to all the identification results.

According to the structure, the back annotation apparatus is capable of reliably selecting a delay value for the logic cell, which varies depending on the overlapping pattern of an electrode pad in relation to the logic cell.

In the above-mentioned back annotation apparatus, the storage unit may store therein (i) a delay value used in the case where the logic cell is to be disposed at a position not overlapped with an electrode pad and (ii) coefficients that are respectively to be used for calculating delay values, each of which is used in the case where the logic cell is to be disposed at a position overlapped with an electrode pad in a predetermined overlapping pattern, and the selection unit may select one of the delay value stored in the storage unit and the delay values calculated using the coefficients, as the delay value for the logic cell according to all the identification results. Here, the predetermined overlapping pattern may be one of (i) an n-type transistor area of the logic cell being to be overlapped with the electrode pad, (ii) a p-type transistor area of the logic cell being to be overlapped with the electrode pad, and (iii) the logic cell being to be entirely overlapped with the electrode pad.

In addition, a mask layout correction apparatus of the present invention comprises: a storage unit storing therein mask layout information that includes information on positions of electrode pads and logic cells in a semiconductor integrated circuit; and a correction unit operable to perform correction for the mask layout information in the case where the mask layout information indicates that a logic cell is to be disposed at a position partially overlapped with an electrode pad in plan view, the correction being made so that the logic cell is to be disposed at one of a position free from being overlapped with an electrode pad and a position entirely overlapped with an electrode pad.

According to the mask layout correction apparatus having the structure above, positions of the logic cells constituting the semiconductor integrated circuit are corrected to be either (1) positions free from being overlapped with electrode pads; or (2) positions entirely overlapped with electrode pads. This eliminates the necessity of determining a different delay value according to the overlapping pattern of an electrode pad in relation to each logic cell. Namely, it is only required to determine a delay value of each logic cell that is to be disposed at either one of (1) and (2) above, and therefore information necessary for determining delay value can be minimized.

In addition, a mask layout correction apparatus of the present invention comprises: a storage unit storing therein mask layout information that includes information on positions of electrode pads and logic cells in a semiconductor integrated circuit; an identification unit operable to identify, with respect to each of the logic cells, whether the logic cell is to be disposed at a position overlapped with an electrode pad in plan view, based on the mask layout information; a selection unit operable to select a delay value for the logic cell according to an identification result obtained by the identification unit; a timing simulation unit operable to perform a timing simulation using the selected delay value for the logic cell; and a correction unit operable to perform correction for the mask layout information based on a result of the timing simulation so that a logic cell to be disposed at a position free from being overlapped with an electrode pad is changed to be disposed at a position overlapped with an electrode pad.

The mask layout correction apparatus having the structure above is capable of accurately simulating operation timings of the semiconductor integrated circuit in which transistor elements are to be disposed at positions overlapped with electrode pads, and correcting the mask layout information based on the simulation result. Accordingly, this prevents, when possible, the occurrence of situations in which a timing error due to a change in the property of a transistor element disposed at a position overlapped with an electrode pad turns out after manufacturing of the semiconductor integrated circuit.

In addition, a mask layout correction apparatus of the present invention comprises: a storage unit storing therein mask layout information that includes information on positions of electrode pads and logic cells in a semiconductor integrated circuit; and a correction unit operable to perform correction so as to add, to the mask layout information, a buffer for offsetting difference between a delay value used in the case where a logic cell is to be disposed at a position overlapped with an electrode pad and a delay value used in the case where the logic cell is to be disposed at a position free from being overlapped with an electrode pad.

In addition, a back annotation method of the present invention comprises: an identification step of identifying, with respect to each logic cell, whether the logic cell is to be disposed at a position overlapped with an electrode pad in plan view, based on mask layout information including therein information on positions of electrode pads and logic cells in a semiconductor integrated circuit; and a selection step of selecting a delay value for the logic cell according to an identification result obtained in the identification step.

In addition, a program of the present invention causes a computer to execute a back annotation process. Here, the back annotation process includes: an identification step of identifying, with respect to each logic cell, whether the logic cell is to be disposed at a position overlapped with an electrode pad in plan view, based on mask layout information including therein information on positions of electrode pads and logic cells in a semiconductor integrated circuit; and a selection step of selecting a delay value for the logic cell according to an identification result obtained in the identification step.

In addition, a computer-readable recording medium of the present invention records thereon a program causing a computer to execute a back annotation process. Here, the back annotation process includes: an identification step of identifying, with respect to each logic cell, whether the logic cell is to be disposed at a position overlapped with an electrode pad in plan view, based on mask layout information including therein information on positions of electrode pads and logic cells in a semiconductor integrated circuit; and a selection step of selecting a delay value for the logic cell according to an identification result obtained in the identification step.

In addition, a method of manufacturing a semiconductor integrated circuit of the present invention comprises: an identification step of identifying, with respect to each logic cell, whether the logic cell is to be disposed at a position overlapped with an electrode pad in plan view, based on mask layout information including therein information on positions of electrode pads and logic cells in a semiconductor integrated circuit; a selection step of selecting a delay value for the logic cell according to an identification result obtained in the identification step; a simulation step of performing a timing simulation of the semiconductor integrated circuit using the selected delay value for the logic cell; a correction step of correcting the mask layout information based on a result of the timing simulation; and a manufacturing step of manufacturing the semiconductor integrated circuit based on the corrected mask layout information.

By manufacturing, according to the above-mentioned method, a semiconductor integrated circuit in which transistor elements are to be disposed at positions overlapped with electrode pads, operation timings of the semiconductor integrated circuit are accurately simulated, and the mask layout information is corrected based on the simulation result. Accordingly, this prevents, when possible, the occurrence of situations in which a timing error due to a change in the property of a transistor element disposed at a position overlapped with an electrode pad turns out after manufacturing of the semiconductor integrated circuit.

### BRIEF DESCRIPTION OF THE DRAWINGS

FIG. 1 shows a layout of electrode pads in a semiconductor IC 1, which is an object of designing;

FIG. 2 is an illustrative drawing showing an adhesion process of the semiconductor IC 1 to a liquid crystal panel 3;

FIG. 3 shows a state in which the semiconductor IC 1 is adhered to the liquid crystal panel 3 with an ACF 2;

FIG. 4 shows an inside layout of a POE disposed at the position shown by a dotted line rectangle 12 in FIG. 1;

FIG. 5 shows a part of a logic circuit of the semiconductor IC 1;

FIG. 6 is a signal timing chart;

FIG. 7 is a functional block diagram of a back annotation apparatus;

FIG. 8 shows a specific example of a logic netlist;

FIG. 9 shows an example of a logic netlist in which a logic cell name has been rewritten;

FIG. 10 shows pressure exerted on electrode pads 111A of a multilayer semiconductor IC 1A when the semiconductor IC 1A is packaged;

FIG. 11 is a functional block diagram of a back annotation apparatus of Modification 1;

FIG. 12 shows an example of a logic netlist in which a logic cell name has been rewritten;

FIG. 13 shows an example of a logic cell overlapped with an electrode pad;

FIG. 14 is a functional block diagram of a back annotation apparatus of Modification 2;

FIG. 15 shows an example of rewriting a logic netlist 102;

FIG. 16 is an illustrative drawing showing a specific example of mask layout correction processing;

FIG. 17 is a logic circuit diagram in which a buffer is inserted by a mask layout correction apparatus; and

FIG. 18 shows a process flow of a method of manufacturing a semiconductor IC according to the present invention.

### BEST MODE FOR CARRYING OUT THE INVENTION

### 1. Embodiment 1

A back annotation apparatus, which is one embodiment of the present invention, is described next with the aid of drawings.

Note that the back annotation apparatus here means a functioning unit for realizing a back annotation function, which is one function of a CAD (Computer Aided Design) system used in designing a semiconductor IC.

The CAD system is a so-called computer composed of a CPU, storage devices such as memories and hard disks, and hardware such as input and output devices. Respective functions of the CAD system are realized by executing a program for the CAD system stored in a storage device.

<Semiconductor IC>

First, a semiconductor IC 1—an object of designing—is explained before the description of the back annotation apparatus.

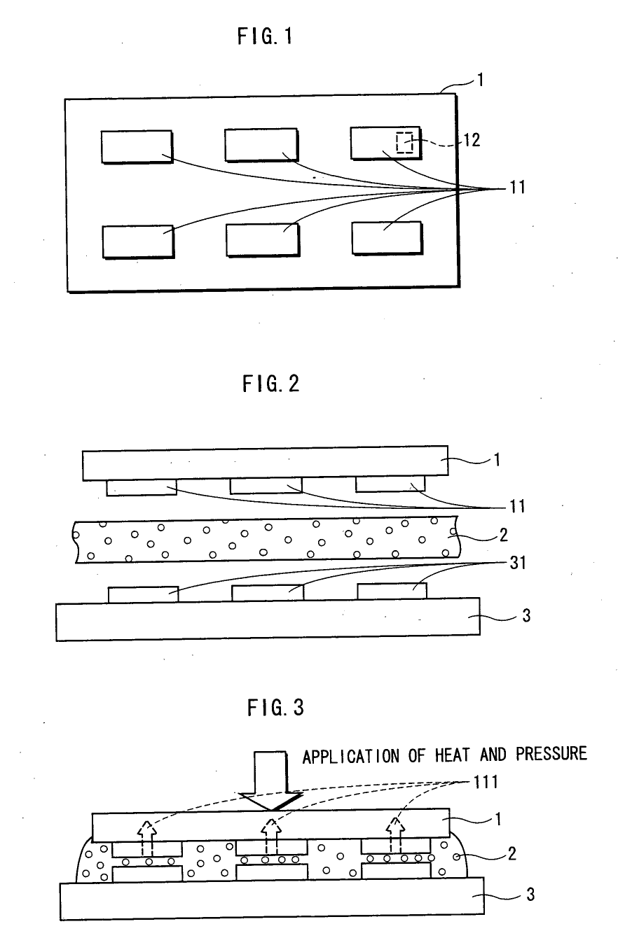

FIG. 1 shows a layout of electrode pads in the semiconductor IC 1.

On the outer layer of the semiconductor IC 1 shown in the figure, six electrode pads 11 are positioned. In addition, a logic cell is disposed, on the inner layer of the semiconductor IC 1, at a position overlapped with one of the electrode pads 11. The position is shown as a dotted line rectangle 12.

A logic cell is also called a gate, and refers to an electronic circuit with a logic expression such as AND, OR, or NOT.

Hereinafter, a logic cell disposed at such a position that it is overlapped with an electrode pad, as shown in the figure, is referred to as a POE (Pad On Element).

Here, a packaging state of the semiconductor IC 1 is explained. FIG. 2 is an illustrative drawing showing an adhesion process of the semiconductor IC 1 to a liquid crystal panel 3.

As shown in the figure, the semiconductor IC 1 is adhered to the liquid crystal panel 3 using an ACF (Anisotropic Conductive Film, also called “ANISOLM”) 2.

The ACF 2 is a thermosetting resin-based adhesive agent, including therein conducting particles with about 3 to 5 μm in size in a dispersed manner.

When heat and pressure are applied to the respective electrodes on the semiconductor IC 1 and the liquid crystal panel 3 with the ACF 2 being sandwiched therebetween, the resin hardens and the distance between each set of electrodes narrows (5 μm or less). Then, the conducting particles in the ACF 2 establish conduction between each set of electrodes.

FIG. 3 shows a state in which the semiconductor IC 1 is adhered to the liquid crystal panel 3 with the ACF 2.

As shown in the figure, pressure ill that is stress resulting from the applied pressure is produced on each electrode pad on the semiconductor IC 1 adhered to the liquid crystal panel 3. Note that the pressure 111 is the pressure at which the transistor elements are not destroyed.

In a supplementary explanation, in the case where the adhesion is made by soldering or wire bonding, there is a risk of destroying the transistor elements by heat and pressure exerted on the electrode pads during the packaging, and therefore the transistor elements are generally not placed at positions overlapped with the electrode pads. However, in the case of the ACF adhesion, the heat and pressure applied to the electrode pads during the packaging are significantly reduced as compared to soldering and wire bonding. As a result, it is less likely that the transistor elements are destroyed, and accordingly the transistor elements can be placed at positions overlapped with the electrode pads.

<POE>

Next is described the POE.

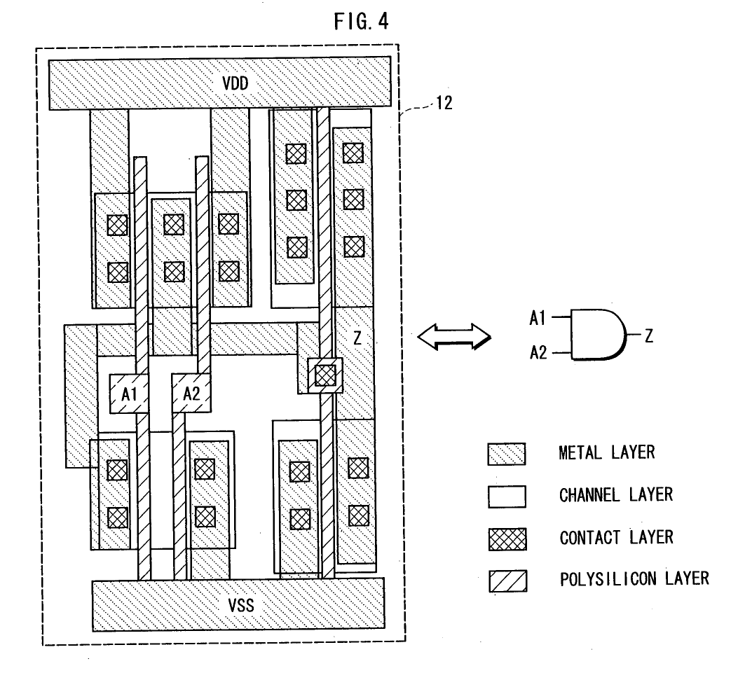

FIG. 4 shows an inside layout of a POE disposed at the position shown by the dotted line rectangle 12 in FIG. 1.

The POE of the figure is an AND circuit, and composed of various layers such as a metal layer, a channel layer, a contact layer and a polysilicon layer.

Because the pressure exerted on the electrode pads is indirectly transferred to the POE, distortion occurs in the layers constituting the POE and the property of the transistor element changes.

As a result, the transmission delay time of the POE differs from that of the same type of logic cell disposed at a position free from being overlapped with an electrode pad.

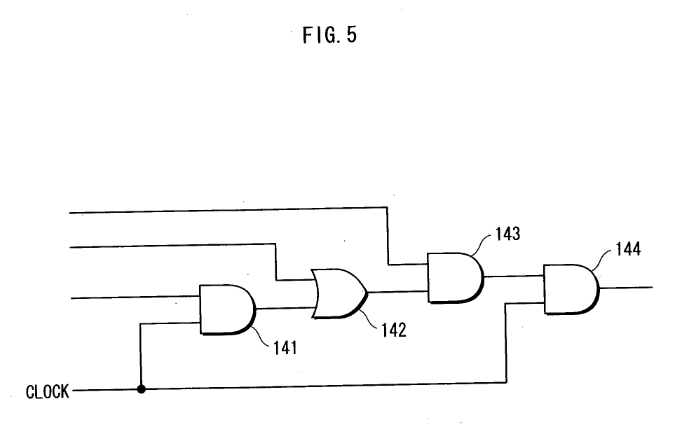

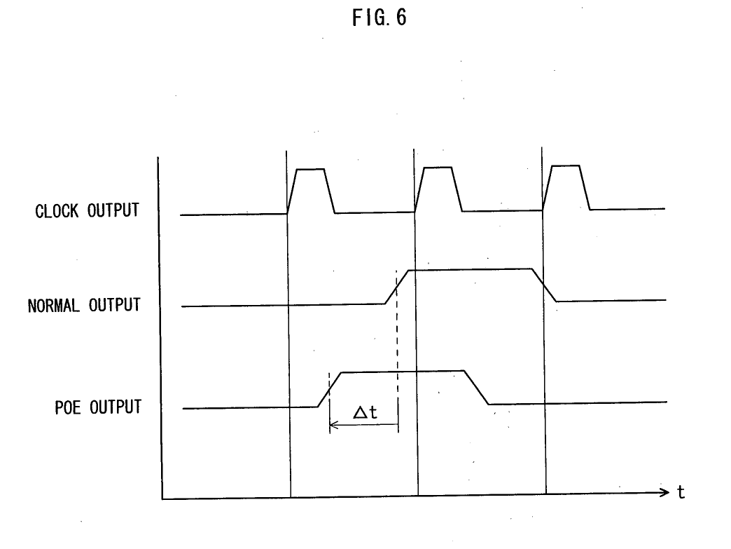

The difference in the transmission delay times is explained with reference to FIGS. 5 and 6.

FIG. 5 shows a part of a logic circuit of the semiconductor IC 1 along with electric connection of an AND circuit 141, an OR circuit 142, an AND circuit 143 and an AND circuit 144.

FIG. 6 is a timing chart showing difference in timing of a signal received by the AND circuit 144 between when the AND circuit 143 of FIG. 5 is a POE and when not.

According to FIG. 6, in the case where the AND circuit 143 is a POE, the signal is output earlier by Δt, as compared to the case where the AND circuit 143 is not a POE.

<Back Annotation Apparatus>

The structure of the back annotation apparatus is described next.

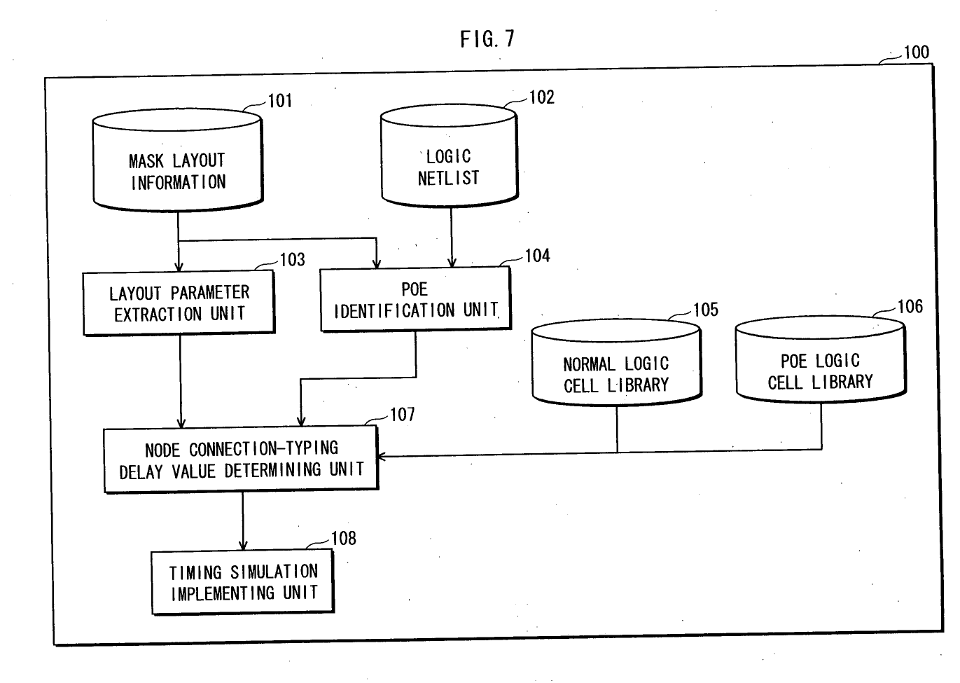

FIG. 7 is a functional block diagram of a back annotation apparatus 100 used for designing the semiconductor IC 1 above.

The back annotation apparatus 100 is a back annotation functioning unit of a CAD system, as described above, and the figure shows, from among various functioning units of the CAD system, only necessary functioning units for realizing the back annotation function.

The back annotation apparatus 100 includes a storage unit, a layout parameter extraction unit 103, a POE identification unit 104, a node connection-typing delay value determining unit 107, and a timing simulation implementing unit 108. Stored in the storage unit are mask layout information 101, a logic netlist 102, a normal logic cell library 105, and a POE logic cell library 106.

The mask layout information 101 is information on wiring of each layer of the semiconductor IC 1 created in the layout design stage, and includes, for example, information on positions and sizes of logic cells and electrode pads, information on positions and width of the wiring, and parameter information related to resistance and capacity of the wiring.

The logic netlist 102 is information on a connection relation between the logic cells constituting the semiconductor IC 1 created in the logic design stage. The connection among logic cells is generally called node connections, and means wiring. An instance indicating each logic cell shown in the logic netlist 102 is associated with a logic cell library using a logic cell name.

In the logic design stage, all instances on the logic netlist 102 are associated with the normal logic cell library 105.

The normal logic cell library 105 is composed of information on a logic expression and driving capacity (e.g. power consumption and a delay value) of each non-POE logic cell. On the other hand, the POE logic cell library 106 is composed of information on a logic expression and driving capacity of each POE logic cell.

The layout parameter extraction unit 103 has a function of extracting parameter information related to the wiring resistance and capacity from the mask layout information 101 that is stored in the storage unit. The extracted parameter information is transmitted to the node connection-typing delay value determining unit 107.

The POE identification unit 104 has a function of identifying whether each logic cell constituting the semiconductor IC is a POE, based on the mask layout information 101 stored in the storage unit.

Specifically speaking, the POE identification unit 104 detects a POE by comparing the information on positions and sizes of electrode pads and the information on positions and sizes of logic cells, and rewrites, as to an instance of the detected POE shown in the logic netlist 102, the logic cell name in a manner that the logic cell can be identified as a POE.

An example of rewriting a logic cell name is shown next.

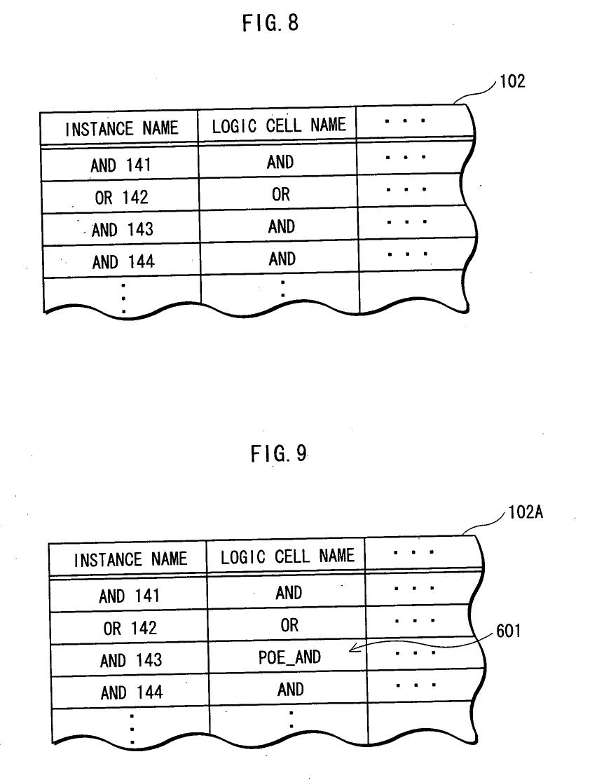

FIG. 8 shows a specific example of the logic netlist 102, while FIG. 9 shows an example of a logic netlist 102A created by rewriting the logic cell name of a logic cell identified as a POE in the logic netlist 102.

When the instance “AND 143” of FIG. 8 is detected as a POE, the POE identification unit 104 rewrites the logic cell name of the instance “AND 143” in the logic netlist 102 from “AND”, which indicates the normal logic cell library 105, to “POE_AND”, which indicates the POE logic cell library 106, as shown by a pointing line 601 of FIG. 9.

The logic netlist 102A resulting from the rewriting is transmitted to the node connection-typing delay value determining unit 107.

The node connection-typing delay value determining unit 107 has a function of determining a wiring delay value with respect to each node connection type based on the parameter information extracted by the layout parameter extraction unit 103, the logic netlist 102A produced by the rewriting operation of the POE identification unit 104, and the normal logic cell library 105 and the POE logic cell library 106 stored in the storage unit.

A wiring delay value includes a delay value of a logic cell. The node connecting-typing delay value determining unit 107 selects a delay value from either the normal logic cell library 105 or the POE logic cell library 106 according to the logic cell name shown in the rewritten logic netlist 102A.

The timing simulation implementing unit 108 has a function of implementing a timing simulation using the wiring delay value determined by the node connection-typing delay value determining unit 107.

As has been explained, when the back annotation apparatus 100 of the present invention is used, the delay value of a logic cell is selected based on whether the logic cell is to be disposed at a position overlapped with an electrode pad. As a result, the back annotation apparatus 100 is capable of accurately simulating operation timings of the semiconductor IC in which transistor elements are to be disposed at positions overlapped with electrode pads.

The delay value of a POE can be found by calculation using a delay value shown in the normal logic cell library 105, instead of storing the POE logic cell library 106. In this case, the back annotation apparatus 100 may store therein coefficients used to calculate POE delay values in the storage unit.

Alternatively, by inputting pressure exerted on the electrode pads, a delay value corresponding to the pressure may be calculated.

For example, testing of electric characteristics is conducted when a semiconductor IC is in the wafer state, and in doing so, a probe pushes the electrode pads down. The POE delay value may be determined by taking into account the pressure caused by the probe.

Furthermore, the following modifications can be considered.

<Modification 1>

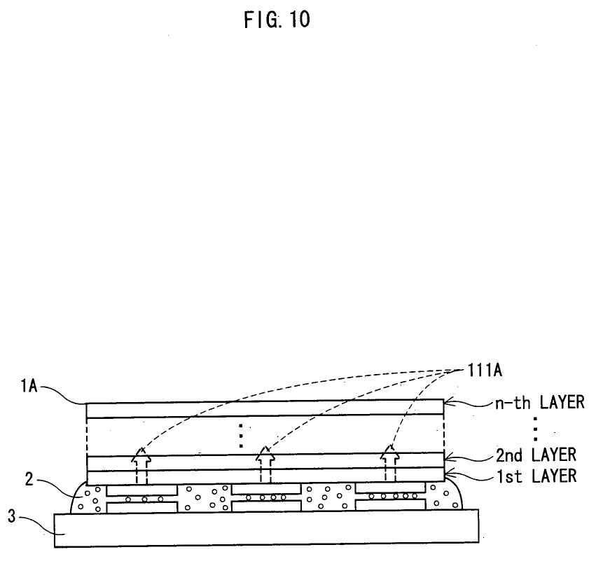

FIG. 10 shows pressure exerted on the electrode pads of a multilayer semiconductor IC when the semiconductor IC is packaged.

As shown in the figure, in the case where a semiconductor IC 1A has a multilayer structure with n layers, pressure 111A directly exerted on the electrode pads 11 is diffused by the layers, and it is accordingly considered that pressure exerted on a POE differs depending on the number of layers.

In view of this, a back annotation apparatus of Modification 1 is characterized by (i) identifying the number of layers when a semiconductor IC, which is an object of designing, has a multilayer structure and (ii) selecting a delay value of a logic cell based on the result of the identification.

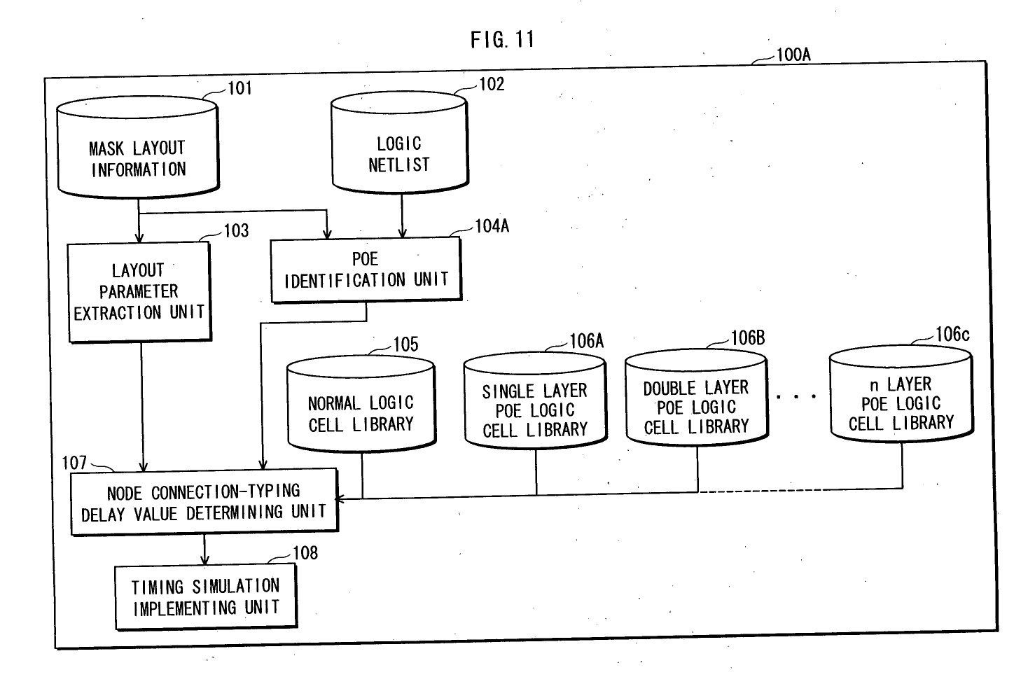

FIG. 11 is a functional block diagram of a back annotation apparatus 100A of Modification 1.

The back annotation apparatus 100A differs from the back annotation apparatus 100 of FIG. 7 in storing, in the storage unit, a single layer POE logic cell library 106A, a double layer POE logic cell library 106B, and an n layer POE logic cell library 106C, each of which is a layer-typing POE logic cell library, instead of the POE identification unit 104 and the POE logic cell library 106. The rest of the back annotation apparatus 100A is the same.

The POE identification unit 104A has a function of identifying the number of layers of the semiconductor IC, besides a function of identifying whether each logic cell constituting the semiconductor IC is a POE, based on the mask layout information 101.

Specifically speaking, the POE identification unit 104A detects a POE and the number of layers of the semiconductor IC by comparing the information on positions and sizes of electrode pads and the information on positions and sizes of logic cells, and rewrites, as to an instance of each detected POE shown in the logic netlist 102, the logic cell name in a manner that the logic cell can be identified as a POE and the number of layers of the semiconductor IC is also identified.

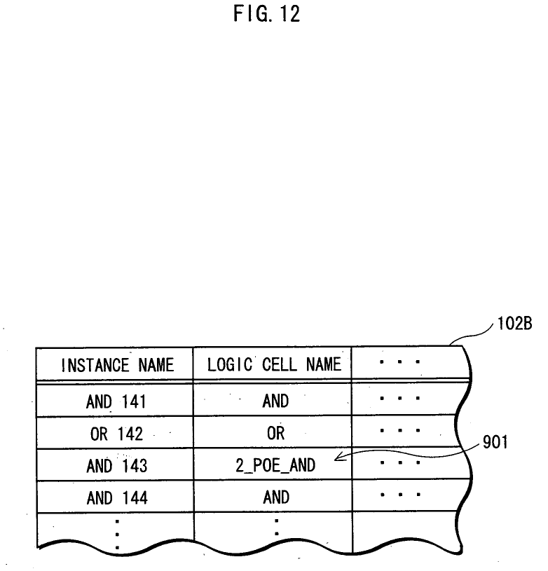

For example, when the instance “AND 143” of FIG. 8 is a POE and the semiconductor IC has a double-layer structure, the POE identification unit 104A rewrites the logic cell name of the instance “AND 143” in the logic netlist 102 from “AND”, which indicates the normal logic cell library 105, to “2_POE_AND”, which indicates the double layer POE logic cell library 106B, as shown by a pointing line 901. FIG. 12 shows an example of a logic netlist 102B created by rewriting the logic netlist 102.

According to the back annotation apparatus of Modification 1, even when a delay value of a POE differs depending on the number of layers of the semiconductor IC, a proper delay value is selected. As a result, a more accurate timing simulation can be performed.

The delay value of a POE according to the number of layers can be found by calculation using a delay value shown in the normal logic cell library 105, instead of storing POE logic cell libraries each associated with the different number of layers. In this case, the back annotation apparatus 100 may store, in the storage unit, coefficients each associated with the different number of layers and used to find the delay value of a POE.

<Modification 2>

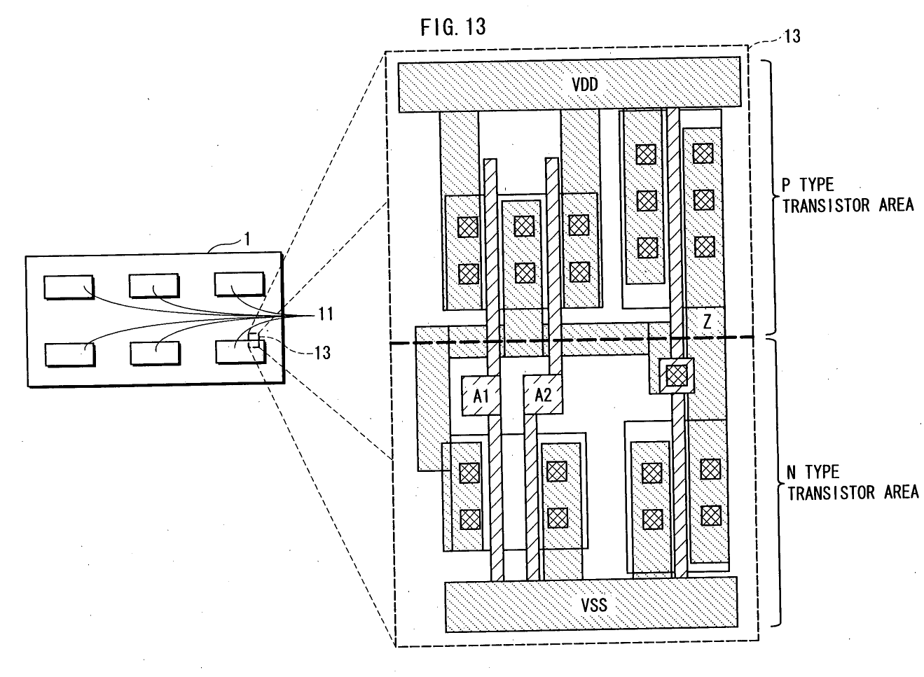

FIG. 13 shows a layout of electrode pads in the semiconductor IC 1, and an inside layout of a logic cell disposed at a dotted line rectangle 13 of the inner layer of the semiconductor IC 1.

The figure shows the state in which, among a P-type transistor area and an N-type transistor area constituting an AND circuit, only the N-type transistor area is overlapped with an electrode pad.

Thus, there can be a case in which a logic cell is disposed so that only a part of the logic cell is overlapped with the electrode pad 11. In this case, the influence of the pressure applied is different as compared to the case where the entire logic cell is overlapped with the electrode pad, and therefore the change in the transmission delay time is also different.

Therefore, a back annotation apparatus of Modification 2 is characterized in that it identifies the overlapping pattern of an electrode pad in relation to a POE and selects a delay value of the logic cell based on the result of the identification.

Here, “the overlapping pattern” indicates one of the following three patterns: (1) the N-type transistor area of the logic cell is overlapped with a pad; (2) the P-type transistor area of the logic cell is overlapped with a pad; and (3) the entire logic cell is overlapped with a pad.

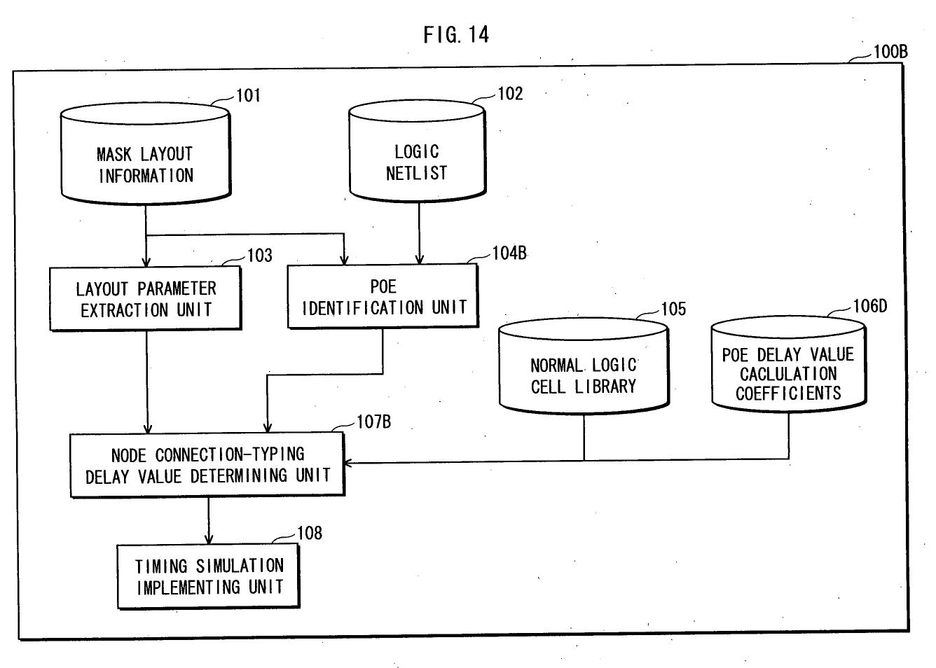

FIG. 14 is a functional block diagram of a back annotation apparatus of Modification 2.

The back annotation apparatus 100B of the figure differs from the back annotation apparatus 100 of FIG. 7 in a POE identification unit 104B and a node connection-typing delay value determining unit 107B, and also in storing POE delay value calculation coefficients 106D in the storage unit, instead of the POE logic cell library 106. The POE delay value calculation coefficients 106D are each associated with a different one of the patterns mentioned above and used to find a delay value corresponding to a transmission delay time, which varies depending on the pattern of the POE overlapped with an electrode pad. The rest of the back annotation apparatus 100B is the same.

The POE identification unit 104B has a function of identifying the pattern of a POE to be overlapped with an electrode pad, besides a function of identifying whether each logic cell constituting the semiconductor IC is a POE, based on the mask layout information 101.

Specifically speaking, the POE identification unit 104B detects a POE and the pattern of the POE to be overlapped with an electrode pad by comparing the information on positions and sizes of electrode pads and the information on positions and sizes of logic cells, and rewrites, as to an instance of the detected POE shown in the logic netlist 102, the logic cell name in a manner that the logic cell can be identified as a POE and the overlapping pattern is also identified.

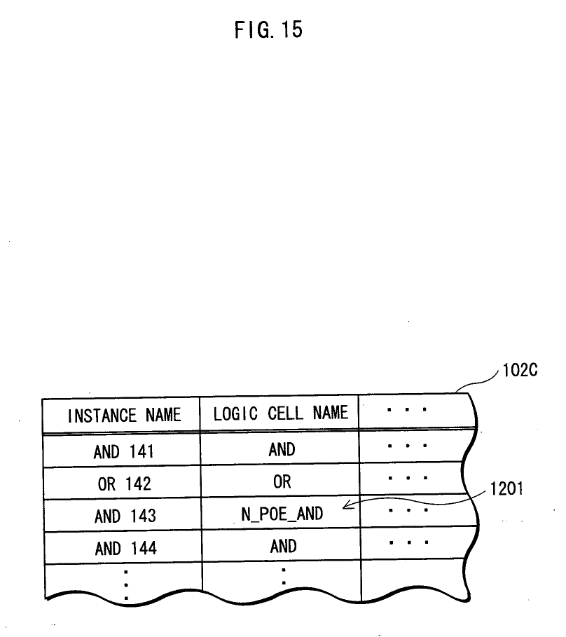

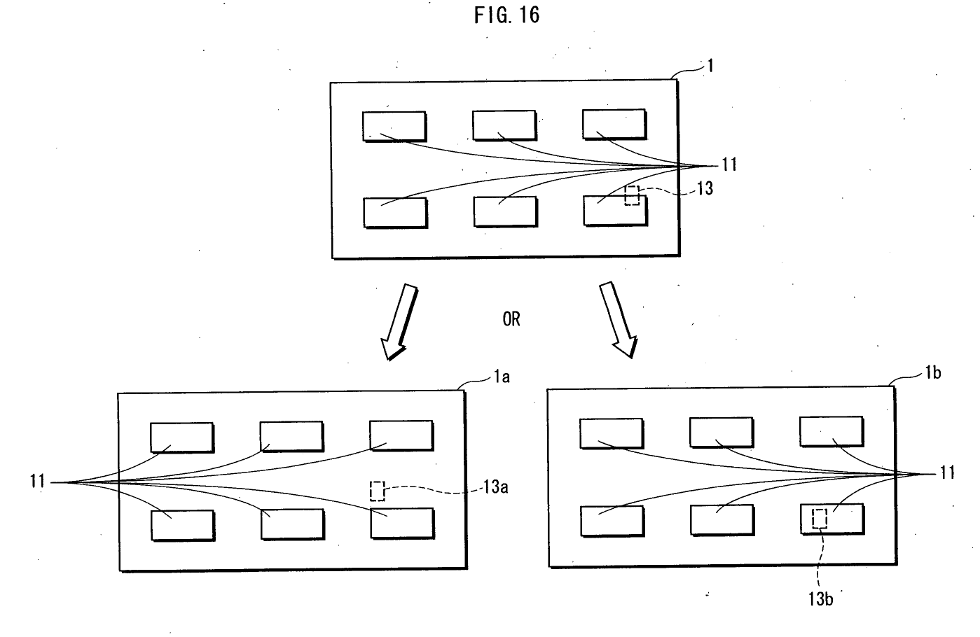

For example, when the instance “AND 143” of FIG. 8 is a POE and only the N-type transistor area is overlapped with an electrode pad, the POE identification unit 104B rewrites the logic cell name of the instance “AND 143” in the logic netlist 102 from “AND”, which indicates the normal logic cell library 105, to “N_POE_AND”, which indicates that only the N-type transistor area is overlapped, as shown by a pointing line 1201. FIG. 15 shows an example of a logic netlist 102C created by rewriting the logic netlist 102.

The node connection-typing delay value determining unit 107B selects a delay value of the logic cell based on the logic cell name shown in the logic netlist 102. That is, if the logic cell name indicates the normal logic cell library 105, the node connection-typing delay value determining unit 107B selects a delay value listed in the normal logic cell library 105. On the other hand, when the logic cell name is, for example, “N_POE_AND” and represents a POE, the node connection-typing delay value determining unit 107B calculates a delay value of the logic cell for the case where only the N-type transistor is to be overlapped with an electrode pad, using the POE delay value calculation coefficients 106D and a delay value shown in the normal logic cell library 105.

Thus, according to the back annotation apparatus of Modification 2, a delay value, which varies depending on the overlapping pattern of the electrode pad in relation to the POE, can be properly selected. As a result, a more accurate timing simulation can be performed.

Note that, instead of the POE delay value calculation coefficients 106D, POE logic cell libraries each associated with a different overlapping pattern may be prestored in the storage unit.

### 2. Embodiment 2

Other than the back annotation apparatus above, the present invention may be configured as a mask layout correction apparatus.

Here, the mask layout correction apparatus means a functioning unit for realizing a mask layout correction function, which is one function of a CAD system used in designing a semiconductor IC.

The mask layout correction apparatus of the present invention is characterized in that, in the case where a logic cell is to be disposed at such a position that only a part of the logic cell is overlapped with an electrode pad, it corrects the mask layout information so that the logic cell is to be disposed one of the following positions: (1) a position free from being overlapped with an electrode pad; and (2) a position entirely overlapped with an electrode pad.

FIG. 16 is an illustrative drawing showing a specific example of mask layout correction processing.

As shown in the figure, in the case where a logic cell is to be disposed at a position shown by a dotted line rectangle 13, a part of which is overlapped by the electrode pad 11 of the semiconductor IC 1, the mask layout correction apparatus performs one of the following corrections: (1) the position of the logic cell is changed to a position shown by a dotted line rectangle 13a of a semiconductor IC 1a, i.e. a position free from being overlapped with an electrode pad; and (2) the position of the logic is changed to a position shown by a dotted line rectangle 13b of a semiconductor IC 1b, i.e. a position entirely overlapped with an electrode pad.

This eliminates the necessity of determining a different delay value according to the overlapping pattern of an electrode pad in relation to each logic cell. Namely, it is only required to determine a delay value of each logic cell that is to be disposed at either one of (1) and (2) above, and therefore information necessary for determining a delay value can be minimized.

In addition, as a result of a timing simulation performed by the back annotation apparatus above, insufficient margin may exist in a node connection.

In such a case, the mask layout correction apparatus of the present invention may make up for the insufficiency of the margin by displacing a logic cell at a position free from being overlapped with an electrode pad to a position overlapped with an electrode pad.

Additionally, in wiring where a logic cell is connected, change in a delay value of the logic cell to be disposed at a position overlapped with an electrode pad may result in hastening the delay that was aimed at the start of the designing. Given this factor, the mask layout correction apparatus of the present invention may perform a correction by adding a buffer to the mask layout information so as to offset the difference between the delay values that vary depending on whether the logic cell is to be disposed at a position overlapped with an electrode pad.

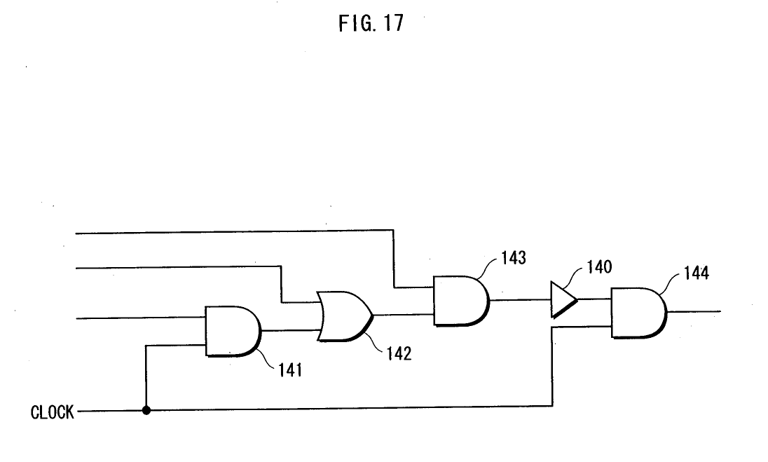

For example, in the case where the AND circuit 143 is a POE, a buffer 140 can be inserted in the connection between the AND circuit 143 and the AND circuit 144, as shown in the logic circuit diagram of FIG. 17.

Herewith, the occurrence of timing errors due to a POE, such as holding errors, can be reduced.

<Additional Particulars>

It is a matter of course that the present invention is not limited to the above-mentioned embodiments. The following is also within the scope of the present invention.

(1) The present invention may be a back annotation method, or a program for realizing the back annotation apparatus and the mask layout correction apparatus above.

The program may be circulated after being recorded on recording media or distributed via various communication channels. Such recording media include an IC card, an optical disk, a flexible disk, and a ROM.

(2) The present invention may be a method of manufacturing a semiconductor IC including a POE.

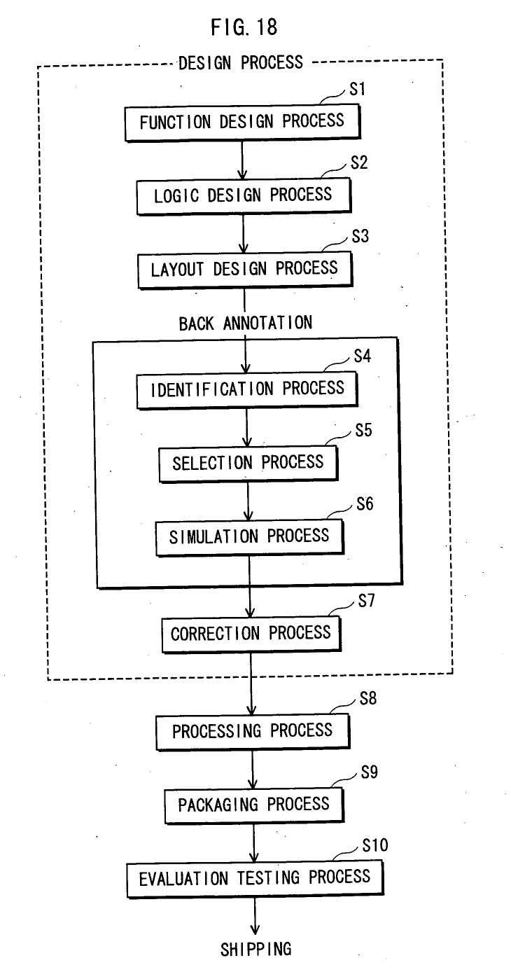

FIG. 18 shows a process flow of the manufacturing method according to the present invention.

The designing process of a semiconductor IC can be largely divided into three processes: a function design process S1; a logic design process S2; and a layout design process S3.

Since being the same as in a conventional manufacturing method, the function design process S1, the logic design process S2, the layout design process S3, a processing process S8, a packaging process S9 and an evaluation testing process S10 are briefly explained here.

In the function design process S1, a specification of a semiconductor IC to be designed is defined, and algorithms are designed which are composed of functional blocks for realizing the specification.

In the logic design process S2, a logic circuit showing electric connections based on the algorithms designed in the function design process S1. The above-mentioned logic netlist is created in this process.

In the layout design process S3, a mask pattern of the semiconductor IC is designed based on the logic netlist created in the logic design process S2. The above-mentioned mask layout information is created in this process.

A back annotation performed after the layout design process S3 includes: an identification process S4; a selection process S5; and a simulation process S6.

In the identification process S4, each logic cell constituting the semiconductor IC is identified whether it is a POE or not based on the mask layout information created in the layout design process S3.

Specifically speaking, a POE is detected by comparing the information on positions and sizes of electrode pads and the information on positions and sizes of logic cells, both of which are written in the mask layout information. Then, as to an instance of the detected POE shown in the logic netlist, the logic cell name is rewritten in a manner that the logic cell can be identified as a POE.

In the selection process S5, a delay value of a logic cell is selected based on the logic netlist that has been rewritten in the identification process S4, and a wiring delay value is calculated.

In the simulation process S6, a timing simulation is performed using the calculated wiring delay value.

In the correction process S7, a correction is performed so as to reflect the result of the timing simulation conducted in the simulation process S6 in the logic netlist and mask layout information.

In the processing process S8′, a mask and a wafer are manufactured based on the mask layout information corrected in the correction process S7.

In the packaging process S9, the wafer on which semiconductor ICs are created is diced, and then each semiconductor IC is joined with other parts and then molded.

In the evaluation testing process S10, a test is conducted to see if the electric characteristics and reliability of each semiconductor IC are ensured, using an automatic test apparatus (i.e. tester).

Semiconductor ICs that have met the criteria of the test conducted in the evaluation testing process S10 are shipped.

By employing the above-mentioned manufacturing method for manufacturing a semiconductor IC that include a POE therein, simulations at design stages can be performed in view of the change in the property of the POE. This eliminates situations where a timing error due to the change in the POE's property turns out in the evaluation testing process S10.

### INDUSTRIAL APPLICABILITY

The present inventions is useful in designing of a semiconductor IC.

1. A back annotation apparatus comprising:
a storage unit storing therein mask layout information that includes information on positions of electrode pads and logic cells in a semiconductor integrated circuit;
an identification unit operable to identify, with respect to each of the logic cells, whether the logic cell is to be disposed at a position overlapped with an electrode pad in plan view, based on the mask layout information; and
a selection unit operable to select a delay value for the logic cell according to an identification result obtained by the identification unit.

2. The back annotation apparatus of claim 1, wherein
the storage unit stores therein (i) a 1^{st} delay value which is used in a case where the logic cell is to be disposed at a position not overlapped with an electrode pad and (ii) a 2^{nd} delay value which is used in a case where the logic cell is to be disposed at a position overlapped with an electrode pad, and
the selection unit selects one of the 1^{st} delay value and the 2^{nd} delay value as the delay value for the logic cell according to the identification result.

3. The back annotation apparatus of claim 2, wherein
the 2^{nd} delay value varies in accordance with pressure imposed on the overlapping electrode pad.

4. The back annotation apparatus of claim 3, wherein
the pressure is pressure generated when a probe for an electric characteristic test is in contact with the overlapping electrode pad in a manufacturing stage where the semiconductor integrated circuit is in a wafer state.

5. The back annotation apparatus of claim 2, wherein
the storage unit stores therein (i) a 1^{st} delay value which is used in a case where the logic cell is to be disposed at a position not overlapped with an electrode pad and (ii) a coefficient to be used for calculating, a 2^{nd} delay value which is used in a case where the logic cell is to be disposed at a position overlapped with an electrode pad, and
the selection unit selects one of the 1^{st} delay value and the 2^{nd} delay value calculated using the coefficient, as the delay value for the logic cell according to the identification result.

6. The back annotation apparatus of claim 5, wherein
the coefficient is used to calculate the 2^{nd} delay value that varies in accordance with pressure imposed on the overlapping electrode pad.

7. The back annotation apparatus of claim 1, wherein
the semiconductor integrated circuit is to have a multilayer structure,
the identification unit identifies a count of wiring layers to constitute the semiconductor integrated circuit in a case where the logic cell is to be disposed at a position overlapped with an electrode pad, and
the selection unit selects the delay value for the logic cell according to all identification results obtained by the identification unit.

8. The back annotation apparatus of claim 7, wherein
the storage unit stores therein (i) a delay value used in a case where the logic cell is to be disposed at a position not overlapped with an electrode pad and (ii) delay values, each of which (a) is used in a case where the logic cell is to be disposed at a position overlapped with an electrode pad and (b) is associated with a different count of the wiring layers, and
the selection unit selects one of the delay values as the delay value for the logic cell according to all the identification results.

9. The back annotation apparatus of claim 7, wherein
the storage unit stores therein (i) a delay value used in a case where the logic cell is to be disposed at a position not overlapped with an electrode pad and (ii) coefficients, each of which (a) is to be used for calculating a delay value which is used in a case where the logic cell is to be disposed at a position overlapped with an electrode pad and (b) is associated with a different count of the wiring layers, and
the selection unit selects one of the delay value stored in the storage unit and the delay values calculated using the coefficients, as the delay value for the logic cell according to all the identification results.

10. The back annotation apparatus of claim 1, wherein
the identification unit identifies an overlapping pattern in a case where the logic cell is to be disposed at a position overlapped with an electrode pad, and
the selection unit selects the delay value for the logic cell according to all identification results obtained by the identification unit.

11. The back annotation apparatus of claim 10, wherein
the storage unit stores therein (i) a delay value used in a case where the logic cell is to be disposed at a position not overlapped with an electrode pad and (ii) delay values, each of which is used in a case where the logic cell is to be disposed at a position overlapped with an electrode pad in a predetermined overlapping pattern, and
the selection unit selects one of the delay values as the delay value for the logic cell according to all the identification results.

12. The back annotation apparatus of claim 10, wherein
the storage unit stores therein (i) a delay value used in a case where the logic cell is to be disposed at a position not overlapped with an electrode pad and (ii) coefficients that are respectively to be used for calculating delay values, each of which is used in a case where the logic cell is to be disposed at a position overlapped with an electrode pad in a predetermined overlapping pattern, and
the selection unit selects one of the delay value stored in the storage unit and the delay values calculated using the coefficients, as the delay value for the logic cell according to all the identification results.

13. The back annotation apparatus of claim 12, wherein
the predetermined overlapping pattern is one of (i) an n-type transistor area of the logic cell being to be overlapped with the electrode pad, (ii) a p-type transistor area of the logic cell being to be overlapped with the electrode pad, and (iii) the logic cell being to be entirely overlapped with the electrode pad.

14. A mask layout correction apparatus comprising:
a storage unit storing therein mask layout information that includes information on positions of electrode pads and logic cells in a semiconductor integrated circuit; and
a correction unit operable to perform correction for the mask layout information in a case where the mask layout information indicates that a logic cell is to be disposed at a position partially overlapped with an electrode pad in plan view, the correction being made so that the logic cell is to be disposed at one of a position free from being overlapped with an electrode pad and a position entirely overlapped with an electrode pad.

15. A mask layout correction apparatus comprising:
a storage unit storing therein mask layout information that includes information on positions of electrode pads and logic cells in a semiconductor integrated circuit;
an identification unit operable to identify, with respect to each of the logic cells, whether the logic cell is to be disposed at a position overlapped with an electrode pad in plan view, based on the mask layout information;
a selection unit operable to select a delay value for the logic cell according to an identification result obtained by the identification unit;
a timing simulation unit operable to perform a timing simulation using the selected delay value for the logic cell; and
a correction unit operable to perform correction for the mask layout information based on a result of the timing simulation so that a logic cell to be disposed at a position free from being overlapped with an electrode pad is changed to be disposed at a position overlapped with an electrode pad.

16. A mask layout correction apparatus comprising:
a storage unit storing therein mask layout information that includes information on positions of electrode pads and logic cells in a semiconductor integrated circuit; and
a correction unit operable to perform correction so as to add, to the mask layout information, a buffer for offsetting difference between a delay value used in a case where a logic cell is to be disposed at a position overlapped with an electrode pad and a delay value used in a case where the logic cell is to be disposed at a position free from being overlapped with an electrode pad.

17. A back annotation method comprising:
an identification step of identifying, with respect to each logic cell, whether the logic cell is to be disposed at a position overlapped with an electrode pad in plan view, based on mask layout information including therein information on positions of electrode pads and logic cells in a semiconductor integrated circuit; and
a selection step of selecting a delay value for the logic cell according to an identification result obtained in the identification step.

18. A program causing a computer to execute a back annotation process, wherein
the back annotation process includes:
an identification step of identifying, with respect to each logic cell, whether the logic cell is to be disposed at a position overlapped with an electrode pad in plan view, based on mask layout information including therein information on positions of electrode pads and logic cells in a semiconductor integrated circuit; and
a selection step of selecting a delay value for the logic cell according to an identification result obtained in the identification step.

19. A computer-readable recording medium recording thereon a program causing a computer to execute a back annotation process, wherein
the back annotation process includes:
an identification step of identifying, with respect to each logic cell, whether the logic cell is to be disposed at a position overlapped with an electrode pad in plan view, based on mask layout information including therein information on positions of electrode pads and logic cells in a semiconductor integrated circuit; and
a selection step of selecting a delay value for the logic cell according to an identification result obtained in the identification step.

20. A method of manufacturing a semiconductor integrated circuit, comprising:
an identification step of identifying, with respect to each logic cell, whether the logic cell is to be disposed at a position overlapped with an electrode pad in plan view, based on mask layout information including therein information on positions of electrode pads and logic cells in a semiconductor integrated circuit;
a selection step of selecting a delay value for the logic cell according to an identification result obtained in the identification step;
a simulation step of performing a timing simulation of the semiconductor integrated circuit using the selected delay value for the logic cell;
a correction step of correcting the mask layout information based on a result of the timing simulation; and
a manufacturing step of manufacturing the semiconductor integrated circuit based on the corrected mask layout information.
